(19) United States
(12) Patent Application Publication
(10) Pub. No.: US 2011/0281083 A1
(43) Pub. Date: Nov. 17, 2011

(54) STRETCHABLE BODY-CONTOURING PROTECTIVE PADS

(75) Inventor: Daniel KIM, Busan (KR)

(73) Assignee: APPLIED FT COMPOSITE SOLUTIONS INC., Las Vegas, NV (US)

(21) Appl. No.: 12/976,832

(22) Filed: Dec. 22, 2010

Related U.S. Application Data
(63) Continuation-in-part of application No. 12/975,249, filed on Dec. 21, 2010.
(60) Provisional application No. 61/288,754, filed on Dec. 21, 2009.

(51) Int. Cl. B32B 3/00

(52) U.S. Cl. 428/190; 428/189

(57) ABSTRACT

The present application describes a padding composite that includes at least one substrate connected to cushioning element having middle and distal part, slidably affixed to the substrate.

### CROSS-REFERENCE TO RELATED APPLICATIONS

The present application is a continuation-in-part application of U.S. patent application Ser. No. 12/975,249, filed Dec. 21, 2010 (pending), which claims priority to U.S. Provisional Patent Application No. 61/288,754, filed Dec. 21, 2009, the contents of which are incorporated by reference herein in their entirety.

### BACKGROUND OF THE INVENTION

### Field of the Invention

The present invention relates to stretchable protective padding material.

### SUMMARY OF THE INVENTION

In one aspect, the invention is drawn to a padding composite comprising at least one substrate connected to cushioning element having a middle and distal part, slidably affixed to the substrate. In one aspect, the substrate may be made of flexible material. The at least one part of the cushioning element may be affixed to the substrate. The part of the cushioning element affixed to the substrate may be the distal part. The cushioning element may be made of foam, or soft plastic. The substrate may be made of flexible, stretchable, or elastic material, such as fabric, mesh, rubber, silicone, soft plastic, synthetic fabric such as spandex or LYCRA®, or composite material that is suitably elastic. The cushioning element may be mounted, glued, sewn, or fused to the substrate. A plurality of cushioning elements may be positioned adjacent to each other and contact each other when the padding composite is not stretched. The cushioning element may have a trapezoid cross-section. The cushioning elements may interlock with each other when the padding composite is not stretched. The cushioning element may be connected to two substrates, at least one on each side of the cushioning element. The cushioning element may be made of at least two different types of materials. The cushioning element may have attached to it another cushioning element of a different material.

In another aspect, the invention is directed to a folding protective plate comprising at least one substrate connected to plate element having a middle and distal part, slidably affixed to the substrate. The substrate may be made of flexible material. At least one part of the plate element may be affixed to the substrate. The part of the plate element affixed to the substrate may be the distal part, which is the adhesion edge. The plate element may be made of hard or resilient material resistant to impact, puncture, or abrasion, such as plastic, ceramic, metal, hard leather, or resilient rubber. The substrate may be made of flexible, stretchable, or elastic material, such as fabric, mesh, rubber, silicone, soft plastic, synthetic fabric such as spandex or LYCRA®, or composite material that is suitably elastic. The plate element may be mounted, glued, sewn, or fused to the substrate. The plate elements may be positioned adjacent to each other and contact each other when the substrate is not stretched. The plate element may be placed over padding material. The padding material may be a padding composite comprising at least one substrate connected to cushioning element having a middle and distal part, slidably affixed to the substrate. The padding material may be comprised of foam element. The adhesion edge may comprise one, two, three, four, five, six, seven, or eight sides of a the plate element along its perimeter. The plate element may be concave shaped. A plurality of plate elements may be joined at a pivot.

### BRIEF DESCRIPTION OF THE DRAWINGS

The present invention will become more fully understood from the detailed description given herein below, and the accompanying drawings which are given by way of illustration only, and thus are not limitative of the present invention, and wherein;

FIG. 1 shows a sectional side view of the protective pads.

FIG. 2 shows a sectional side view of the protective pads.

FIG. 3 shows a sectional perspective view of the protective pads.

FIG. 4A shows a sectional perspective view of the protective pads.

FIG. 4B shows a sectional side view of the protective pads.

FIG. 4C shows a sectional perspective view of the protective pads.

FIG. 4D shows a sectional side view of the protective pads.

FIG. 5 shows a sectional side view of the protective pads.

FIG. 6 shows a sectional side view of the protective pads.

FIG. 7 shows a sectional side view of the protective pads.

FIG. 8 shows a sectional side view of the protective pads.

FIG. 9 shows a sectional side view of the protective pads.

FIG. 10 shows a sectional side view of the protective pads.

FIG. 11 shows a sectional side view of the protective pads.

FIG. 12 shows a sectional side view of the protective pads.

FIG. 13 shows a sectional side view of the protective pads.

FIG. 14 shows a sectional side view of the protective pads.

FIG. 15 shows a plan view of the protective pads.

FIG. 16 shows a plan view of the protective pads.

FIG. 17 shows a plan view of the protective pads.

FIG. 18 shows a plan view of the protective pads.

FIG. 19 shows an exploded side view of the protective pads.

FIG. 20 shows a side view of the protective pads.

FIG. 21 shows a plan view of the protective pads.

FIG. 22 shows a plan view of the protective pads.

FIG. 23 shows a plan view of the protective pads.

FIG. 24 shows a plan view of the protective pads.

FIG. 25 shows a plan view of the protective pads.

FIG. 26 shows a plan view of the protective pads.

FIG. 27 shows a plan view of the protective pads.

FIG. 28 shows a side view of the protective pads.

FIG. 29 shows a plan view of the protective pads.

FIG. 30 shows a plan view of the protective pads.

FIG. 31 shows an exploded perspective view of the protective pads.

FIG. 32 shows shapes of cushioning elements.

FIG. 33 shows a shape of a cushioning element.

FIG. 34 shows a shape of a cushioning element.

### DETAILED DESCRIPTION OF THE PREFERRED EMBODIMENTS

In the present application, “a” and “an” are used to refer to both single and a plurality of objects.

The invention includes a protective padding material that is lightweight, stretchable, and can be shaped so that the padding material follows the contour of the human body, for greater comfort and flexibility. Optionally, the protective padding material may be used to cover or protect animals or objects that move, stretch, or flex.

The protective padding material includes an arrangement of cushioning elements with shock absorbing or impact resistant properties that are positioned relative to each other, and then mounted on at least one sheet of flexible or stretchable substrate defined by a width and depth, in a manner that permits the cushioning elements to move in relation to each other, and to stretch with the substrate on which the elements are mounted.

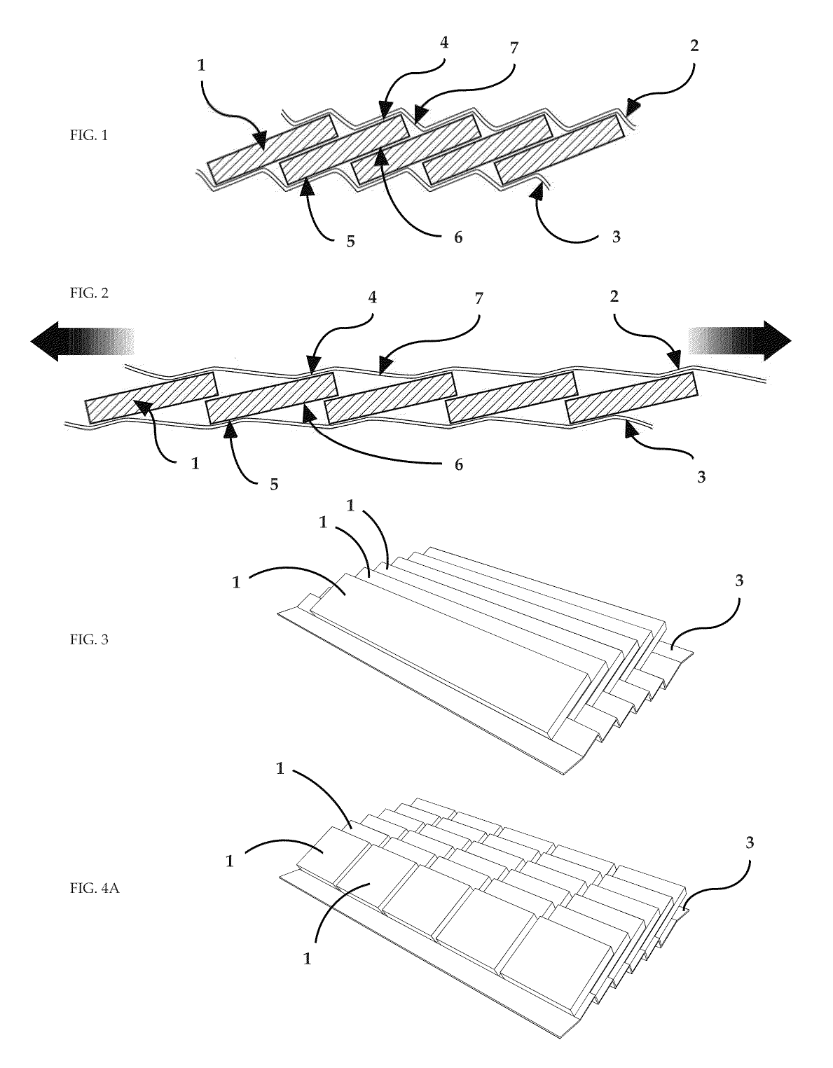

FIGS. 1 and 2 depict one embodiment of the invention. The cushioning element 1 may be made of any material with suitable shock absorbing properties, such as foam, soft plastic, or other similar material. Alternatively, the cushioning elements may also be made of hard materials resistant to impact or shock, such as impact resistant plastic, hard leather, or other natural or synthetic materials with protective qualities, or a combination thereof.

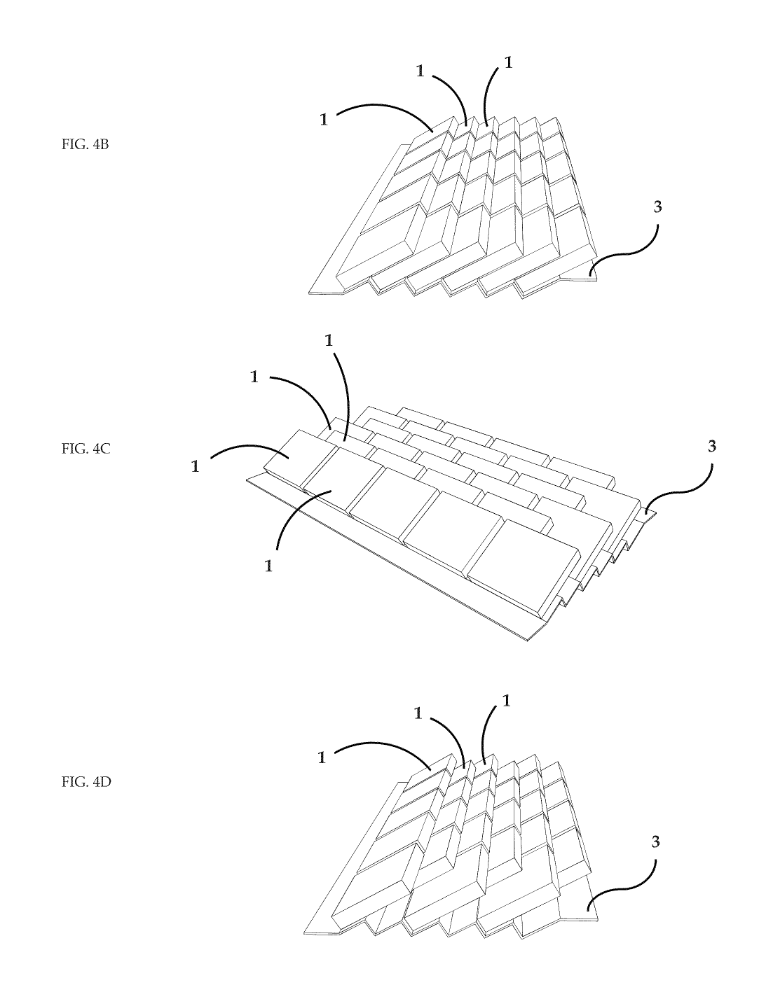

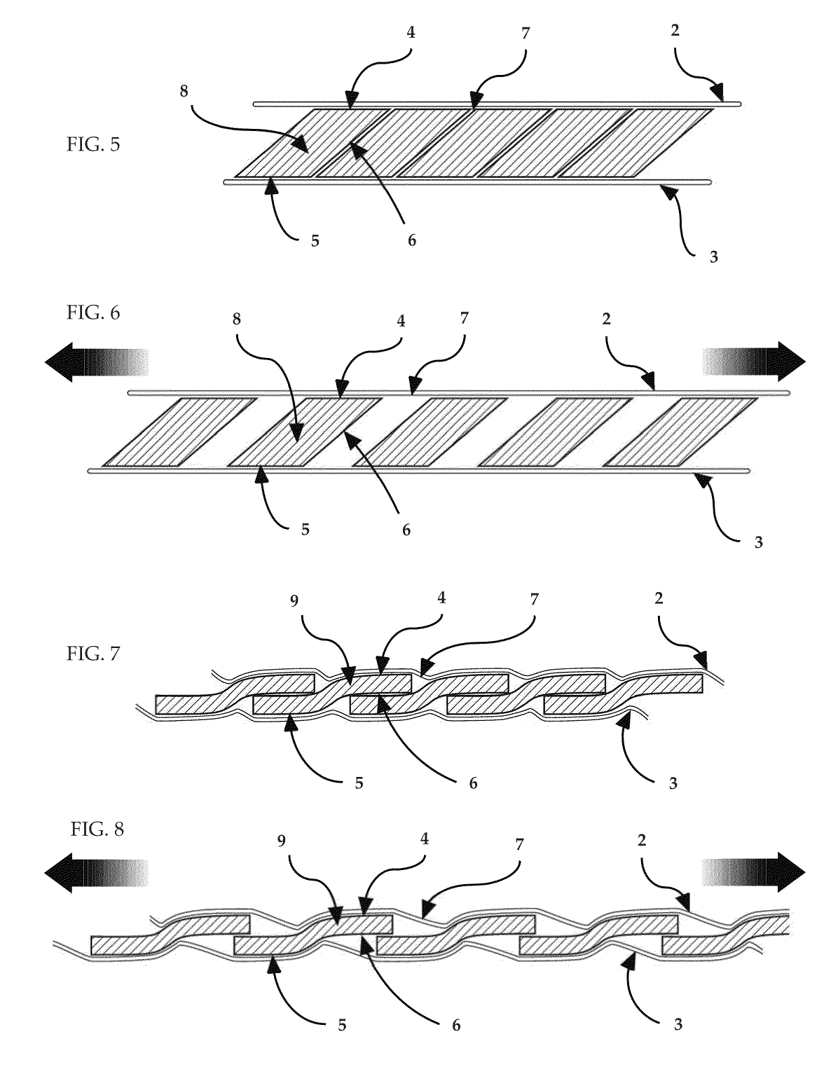

The cushioning elements may be shaped like flat sheets, or like strips as depicted in FIG. 3, or made in any other suitable shape, such as squares as depicted in FIG. 4, hexagons, and the like.

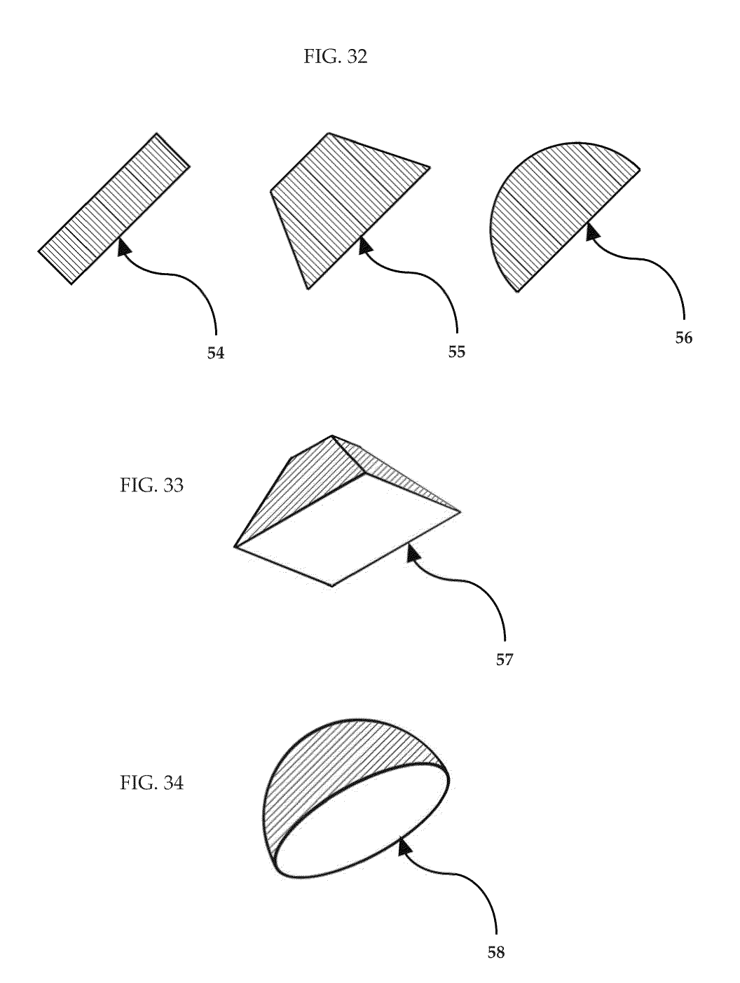

The cushioning elements may also have a convex or semi-spherical shape as depicted in FIG. 34, a pyramidal shape as depicted in FIG. 33, or other complex three dimensional shape. FIG. 32 shows the cross section 56 of a cushioning element that has a convex or semi-spherical shape. FIG. 32 also shows the cross section 55 of a cushioning element that has a pyramidal shape.

In another embodiment, the protective padding material may be made by stacking more than one cushioning element substantially diagonally, so that each cushioning element partially overlaps with at least one other cushioning element as in the manner depicted in FIG. 1.

The cushioning elements may be laid out on a substrate in a one dimensional array as depicted in FIG. 3 in which a cushioning element is placed along a designated width of the substrate across a defined depth of the substrate; or in a two dimensional array as depicted in FIGS. 4A and 4B, in which several cushioning elements are placed along a designated width of the substrate across a defined depth of the substrate.

Optionally, the cushioning elements may also be laid out on a substrate in a two dimensional array as depicted in FIGS. 4C and 4D in which several cushioning elements are placed along a designated width of the substrate across a defined depth of the substrate, and the individual cushioning elements are positioned in an overlapping pattern, so that the gap or spacing between the cushioning elements in one row in the array is followed by a resilient element in the following row in the array.

The placement of the cushioning element in an overlapping pattern may have a functional advantage. If the cushioning elements are placed in alignment, so that the spacing or gap between the cushioning elements are aligned, then laterally stretching the underlying substrate will tend to create a gap between the cushioning elements. Placing the cushioning elements in an overlapping pattern prevents the gap from being created even if the substrate below is laterally stretched.

The cushioning elements 1 may be mounted, glued, sewn, or fused to at least one substrate 3 made of flexible, stretchable, or elastic material, such as fabric, mesh, rubber, silicone, soft plastic, synthetic fabric such as spandex or LYCRA®, or composite material that is suitably elastic.

In another embodiment, the cushioning elements 1 are mounted or glued to a second substrate 2, also made of flexible, stretchable, or elastic material.

A variety of adhesives are contemplated to bond the cushioning elements to the substrates 2 and 3.

Substrate 3 is glued to only the substrate contacting portion of the surface of each cushioning element 5. Glue or adhesive is not applied to the substrate contact free portion of the surface of each cushioning element 6 that is adjacent to other cushioning elements, so that each cushioning element is allowed to move or slide in relation to the other cushioning elements adjacent to it.

Similarly, substrate 2 is glued to only a substrate contacting portion of the surface of each cushioning element 4.

Areas of substrates 2 and 3 that do not touch the surface of the cushioning elements as depicted in FIG. 1 are not glued to the cushioning elements. By way of example, as depicted in FIG. 1, area 7 of substrate 2 is not glued to the cushioning elements.

Substrates 2 and 3 can be pulled or stretched by equal or different force.

FIG. 1 depicts the entire assembly in resting state. FIG. 2 depicts force being applied to the assembly. The arrows in FIG. 2 show force being applied to the assembly, and “stretching” the portions of substrates 2 and 3 that are not bound or glued to the individual cushioning elements.

When substrates 2 or 3, or both of them, are pulled or stretched, each cushioning element 1 moves with the substrate because they are partially affixed to the substrate in certain areas 4 and 5. Because no glue or adhesive was applied to areas 6 of each cushioning element adjacent to the other cushioning elements, each cushioning element can move, or “slide”, in relation to the other cushioning elements.

As seen in FIG. 2, when substrates 2 and 3 are pulled or stretched, the portions of substrates 2 and 3 that are not bound or glued to the individual cushioning elements such as shown in the substrate contact free portion 7, stretch to the extent that substrates 2 and 3 are made of elastic, stretchable, or otherwise deformable materials.

The extent to which the cushioning element can move in relation to each other is affected by the characteristics of substrate 2 and substrate 3, the substrate contacting portion surface areas 4 and 5 bound to the substrates, and the areas of the substrate such as the substrate contact free portion 7 not bound to the cushioning elements.

Substrates 2 and 3 can be selected, so that when the entire assembly is stretched, the individual cushioning elements 1 do not move or slide so far as to create a gap between the cushioning elements.

By way of example only, substrate 3 made of LYCRA® or other stretchable fabric may be cut and sewn or welded in the shape of a tube, inside substrate 2 also made of LYCRA® and cut and sewn or welded in a tubular shape of slightly larger diameter, with the cushioning elements sandwiched between substrates 2 and 3 and arranged in the manner depicted in FIGS. 1 and 2. Without limitation, the entire assembly may be used as elbow or knee pads.

Additionally, the assembly may be given a flat shape, and sewn onto compression shirts or shorts for protection, as protective padding for athletic or industrial use.

FIG. 5 depicts an alternative embodiment, in which the cushioning elements 8 have a trapezoidal cross-section, so that the elements can sit packed close to each other when no force or pull is applied to the assembly, or to substrates 2 or 3, or to both of them.

Substrates 2 and 3 are glued only to the substrate contacting portions 4 and 5, respectively, of the top and bottom surfaces of each cushioning element. Again, glue or adhesive is not applied to the surface of each cushioning element that is adjacent to other cushioning elements 6, so that each cushioning element can move away from the other cushioning elements adjacent to it.

As depicted in FIG. 6, as force is applied and the entire assembly, or substrate 2 or 3, or both, are pulled as shown by the arrows, the portion of substrates 2 and 3, such as the substrate contact free portion 7 that are not glued to the cushioning elements 8 will stretch.

Again, substrates 2 and 3 can be selected of suitable materials, so that when the entire assembly is stretched, the individual cushioning elements 8 do not move or slide so far as to create a gap between the cushion elements.

FIGS. 7 and 8 depict another alternative embodiment, in which the cushioning elements 9 have a flattened “s” cross-section, so that the elements can be stacked close to each other when no force or pull is applied to the assembly, or to substrates 2 or 3, or to both of them.

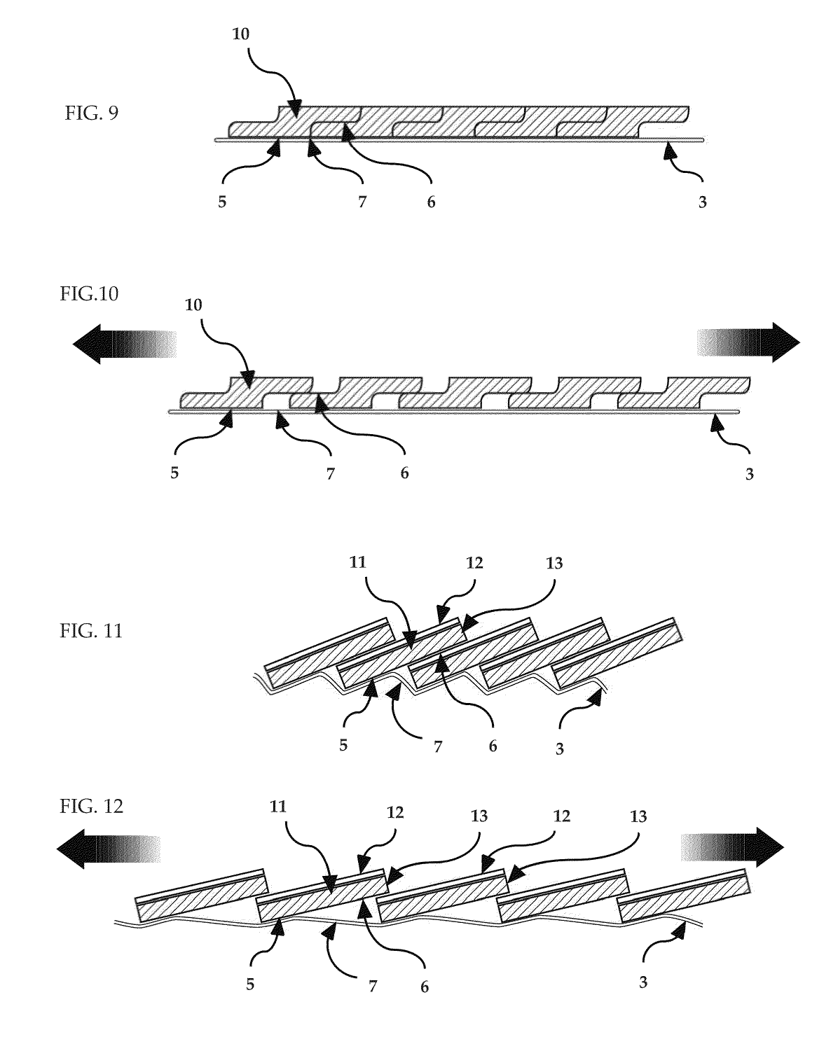

FIGS. 9 and 10 depict yet another alternative embodiment, in which the cushioning elements 10 have a cross-section that allow the cushioning elements to be stacked close to each other and “interlock” when no force or pull is applied to the assembly, or to substrates 2 or 3, or to both of them.

FIGS. 11 and 12 depict an alternative embodiment of the protective padding material shown in FIGS. 1 and 2, where substrate 2 may be optionally present but is omitted in FIGS. 11 and 12, and the cushioning elements 11 are made of two different materials 12 and 13 glued to each other. Optionally, material 12 can be made of a harder or more brittle laminate, such as plastic, metal, ceramic, or other material resistant to puncture, abrasion, or impact against sharp objects; and material 13 can be made of a softer or more elastic materials, such as foam, rubber, or other compounds with shock absorbing qualities.

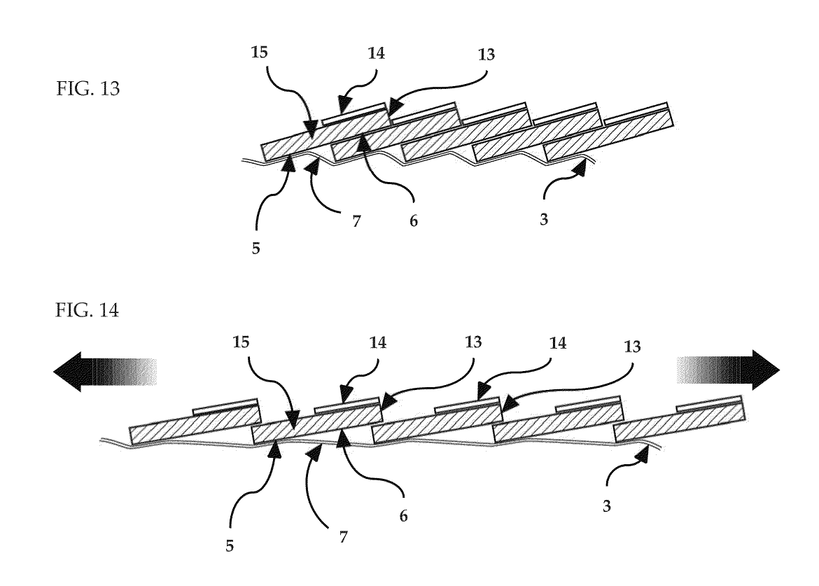

FIGS. 13 and 14 depict an alternative embodiment of the protective padding material shown in FIGS. 11 and 12, where the cushioning elements 15 are made of two different materials 14 and 13 glued to each other. Optionally, material 14 can be made of a harder or more brittle compound, such as plastic, ceramic, metal, or other material resistant to puncture or deformation, and covers only a portion of the surface of material 13.

In another aspect, the present invention is directed to a folding protective plate.

In one embodiment, the invention includes a protective plate comprised of multiple plate or shell elements that fold or slide against each other to change the shape or conformation of the entire assembly. When attached or affixed to an outer layer of garments, the change in shape or conformation makes the protective plate partially flexible, and permits the wearer to articulate his or her limbs and flex the body parts covered by the protective plates more comfortably.

In a preferred embodiment, the protective plate is placed on top of a protective padding material with shock absorbing qualities. The protective padding material is intended to be placed between at least one of the protective plate and the body, or between the protective plate and the outer layer of garment or fabric that envelops the body, such as a knee or elbow guard.

Optionally, the protective padding material may be of the type depicted in FIGS. 1-14.

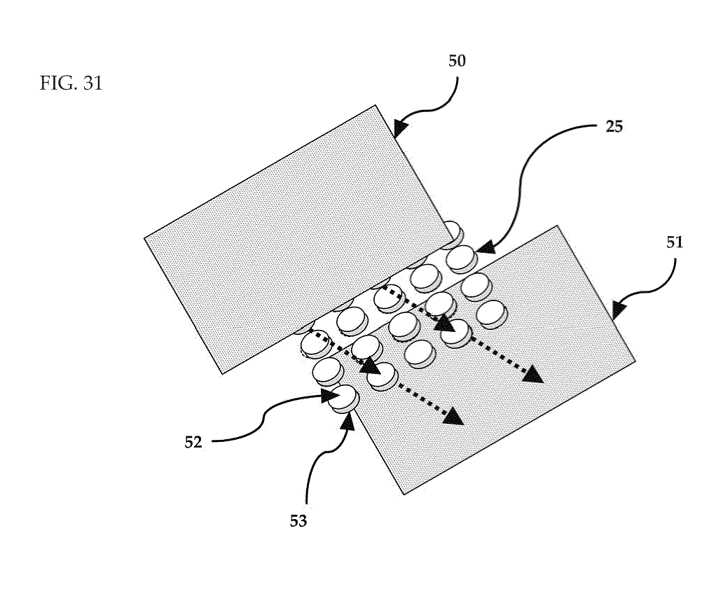

Alternatively, as shown in FIG. 31, the protective padding material may be made of multiple foam elements 25 sandwiched between two substrates 50 and 51 made of flexible, stretchable, or elastic material, such as fabric, mesh, rubber, silicone, soft plastic, synthetic fabric such as LYCRA®, or composite material that is suitably elastic. The foam elements 25 are preferably made of shock absorbing foam; however, the term “foam elements” is not intended to serve as a limitation on the type of materials that can be used to make foam elements 25. Thus the foam elements can optionally be made of any other shock absorbing material, such as rubber, elastomer, plastic, and so forth, including any combination of such materials. In this embodiment, one surface 52 of each foam element is bound or glued to a substrate 50, and the other surface is bound or glued to another substrate 51.

Although in FIG. 31 the foam elements 25 are depicted as having a circular cross-section, the foam elements may have a variety of shapes, including, without limitations, square, oval, or ovoidal cross-sections.

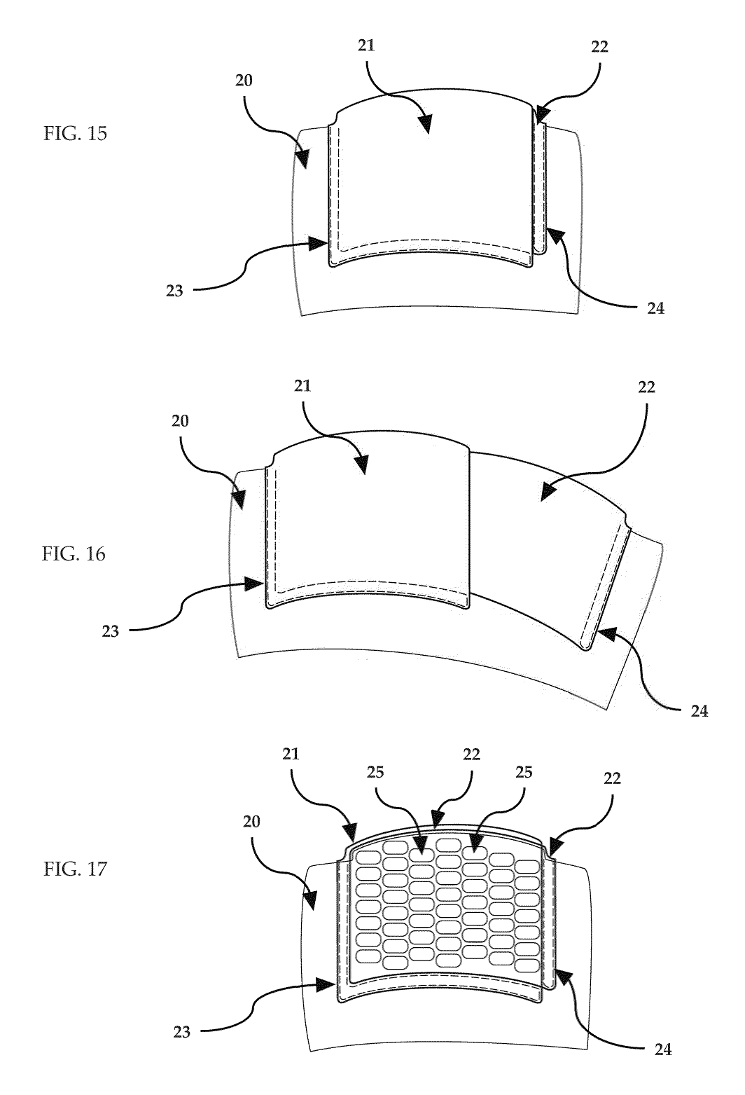

FIGS. 15 and 17 depict one embodiment of the protective plate. Plate elements 21 and 22 may be made of hard or resilient materials resistant to impact, puncture, or abrasion, such as plastic, ceramic, metal, hard leather, or resilient rubber. Although in FIG. 15 plate elements 21 and 22 are shown as rectangular in shape, they may be made of a variety of shapes.

Plate element 21 may be positioned above flexible substrate 20 made of a material such as fabric, mesh, rubber, silicone, soft plastic, synthetic fabric such as LYCRA®, or elastic composite material. Optionally, flexible substrate 20 may be the same substrate as the substrate 51 shown in FIG. 31. Also optionally, flexible substrate 20 may be the outer layer of a garment, clothing, protective wear, or flexible protective gear.

Plate element 22 may also be positioned above substrate 20, but between plate element 21 and the substrate 20.

Plate element 22 may be glued or affixed to substrate 20 along an adhesion edge 24 of plate element 22. Preferably, adhesion edge 24 encompasses one edge of one side of the plate element 22. However, the adhesion edge 24 may encompass up to three edges of three sides of plate element 22, if plate element 22 is rectangular, square or otherwise has four sides in shape. Alternatively, adhesion edge 24 may not run along the entire perimeter of plate element 22.

Plate element 21 may be glued or affixed to substrate 20 along adhesion edge 23 of plate element 21. Preferably, adhesion edge 23 encompasses one edge of one side of plate element 21. However, the adhesion edge 23 may encompass up to three edges of three sides of plate element 21, if plate element is rectangular, square or otherwise has four sides in shape. The adhesion edge 23 does not run along the entire perimeter of plate element 21. Regardless of the shape of the plates 21 and 22, a portion of the plate along an edge of the plate is bound or affixed to the substrate so as to allow another plate to either slide over or under it.

While the drawings in FIGS. 15-30 exemplify substantially four-sided plate elements 21 and 22 which are glued to the flexible substrate 20 along three of its side edges and the fourth side edge is not glued to the substrate, and the bottom plate element 22 slides in and out through an opening created on the fourth side of plate element 21, according to the present invention, the plate elements 21 and 22 may be made of any shape, including but not limited to two sides, three sides, four, five, six, seven, eight sides and so forth, and including even round/circular/oblong shape plate with only one “contiguous edge”. In the instance of the shape of the upper plate element 21 having one contiguous edge, its adhesion edge may not encompass the entire perimeter of the plate element because an opening is created bordered by the flexible substrate 20 and a side of the plate element 21 to allow the bottom plate element 22 to slide in or out. In the instance of the shape of the bottom plate element 22 having one contiguous edge, its adhesion edge may not encompass the entire perimeter of the plate element 22 because an opening is created bordered by the flexible substrate 20 and a side of the plate element 22 to allow the padding substrate 28 to be positioned underneath the plate element 22, or for the padding substrate to slide in or out through the opening created between the flexible substrate 20 and the bottom plate element 22. The plate elements 21 and 22 may also include a combination of round edges and linear edges. The plate elements 21 and 22 may be shaped in a variety of ways so long as the plate elements 21 and 22 are fixed on the flexible substrate 20 with an opening that allows its partner plate element or padding substrate 28 to be positioned or slide inside through the opening. With regards to the bottom plate element 22, if no plate element or any padding substrate is to be positioned underneath the bottom plate element 22, then optionally, the entire perimeter of its edge may be glued to the substrate 20.

Plate element 22 may be located, or “sandwiched,” between plate element 21 and substrate 20. Optionally, plate element 21 may be concave in shape, curved, or shaped so as to sit above plate element 22 while maintaining adhesion to substrate 20.

Optionally, protective padding material may be placed between plate element 22 and substrate 20, either before or after plate elements 21 or 22 are affixed to substrate 20.

The protective padding material may be of the type depicted in FIGS. 1-14. Alternatively, the protective padding material may include the padding assembly shown in FIG. 31.

FIG. 17 depicts the protective plate assembly with the padding material incorporating foam elements 25, placed between the plate element 22 and the flexible substrate 20, in resting state. Although in FIG. 17 the foam elements 25 are depicted as having an oval or ovoidal cross-section, the foam elements may have a variety of shapes.

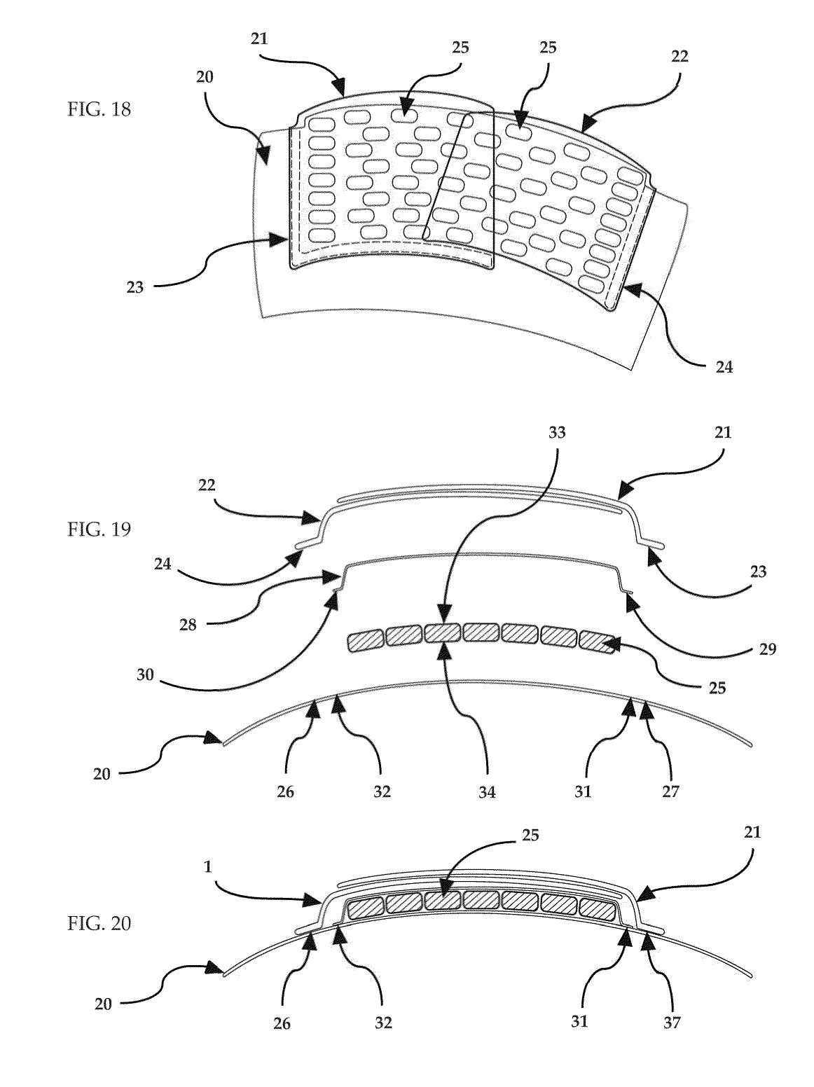

FIGS. 16 and 18 depict flexible substrate 20 being stretched along its plane. When force is applied to flexible substrate 20 so as to stretch or deform it, the surface of the flexible substrate moves in relation to plate elements 21 and 22, with the exception of adhesion edge 23 of plate element 21, and adhesion edge 24 of plate element 22, which remain affixed to the flexible substrate. However, because plate elements 21 and 22 are not glued or bonded to each other, they move, or slide, in relation to each other. FIG. 16 shows plate element 22 “sliding out” in relation to plate element 21.

FIG. 18 depicts the protective plate assembly with the padding material incorporating foam elements 25, placed between the plate element 22 and the flexible substrate 20, being stretched.

To the extent that flexible substrate 20 is optionally the same as substrate 51 shown in FIG. 31, and the foam elements are also affixed to flexible substrate 20, the foam elements also move (or “stretch”) in relation to each other when flexible substrate 20 is stretched or deformed.

FIGS. 19 and 20 depict a cross-sectional view of the protective plate assembly shown in FIGS. 15-18. As explained hereinabove, plate element 21 is bonded or affixed to area 27 of flexible substrate 20 along the adhesion edge 23. Plate element 22 is bonded or affixed to area 26 of flexible substrate 20 along the adhesion edge 24. Optionally, surfaces 33 of foam elements 25 are bonded to padding substrate 28, which may optionally be the same as substrate 50 depicted in FIG. 31, and surfaces 34 of the foam elements are bonded to flexible substrate 20, which may optionally be the same as substrate 51 depicted in FIG. 31. A the padding substrate 28 is bonded or affixed to the flexible substrate 20 along its edges 29 and 30, making contact with areas 31 and 32, respectively, of flexible substrate 20.

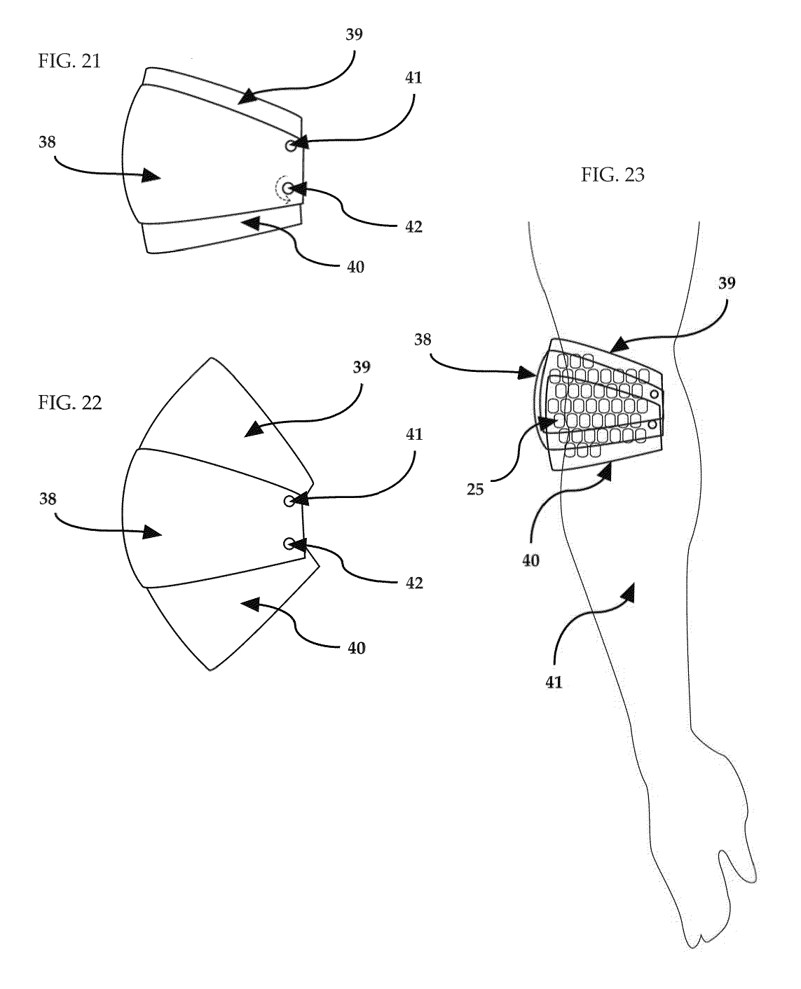

FIGS. 21 and 22 depict an alternative embodiment of the protective plate assembly and the plate elements, in which the plate elements are concave (or “shell-like”) in shape. The plate elements 38, 39 and 40 may be foldable relative to each other. For example, if the plate elements 38, 39 and 40 are folded together, plate element 40 may be positioned underneath plate element 39, and plate element 39 may be positioned underneath plate element 38, and so forth. Plate elements 38 and 39 may be joined by pivot 41. Plate elements 38 and 40 may be joined by pivot 42. FIGS. 21 and 22 provide examples of how such folded and flexible pivoted protective plate assembly may be made.

The protective plate assembly may be preferably attached to a flexible substrate 20 (not depicted in FIGS. 21 and 22) by pivot points 41 and 42.

As shown in FIG. 22, pivot 41 permits plate element 39 to “pivot out” from below plate element 38. Likewise, pivot 42 permits plate element 40 to “pivot out” from below plate element 38.

Optionally, the protective padding material may be placed underneath the protective plate assembly incorporating plate elements 38, 39, and 40. Again, the protective padding material may be of the type depicted in FIGS. 1-14. Alternatively, the protective padding material may include the padding assembly shown in FIG. 31.

FIG. 23 shows the protective plate assembly depicted in FIGS. 21 and 22 positioned against a person's arm 41, to operate like a protective elbow guard or elbow pad. Preferably, protective padding material is placed underneath the protective plate assembly, to provide cushioning and additional shock protection. Accordingly, FIG. 23 depicts the protective plate assembly with the padding material incorporating foam elements 25, placed underneath plate elements 38, 39, and 40. In this embodiment, the protective plate assembly and the padding material are optionally bonded or affixed to a flexible or stretchable substrate, such as flexible substrate 20 (not depicted in FIG. 23), that “wraps” around the wearer's elbow or arm, with the protective plate assembly and the padding material positioned over the person's elbow.

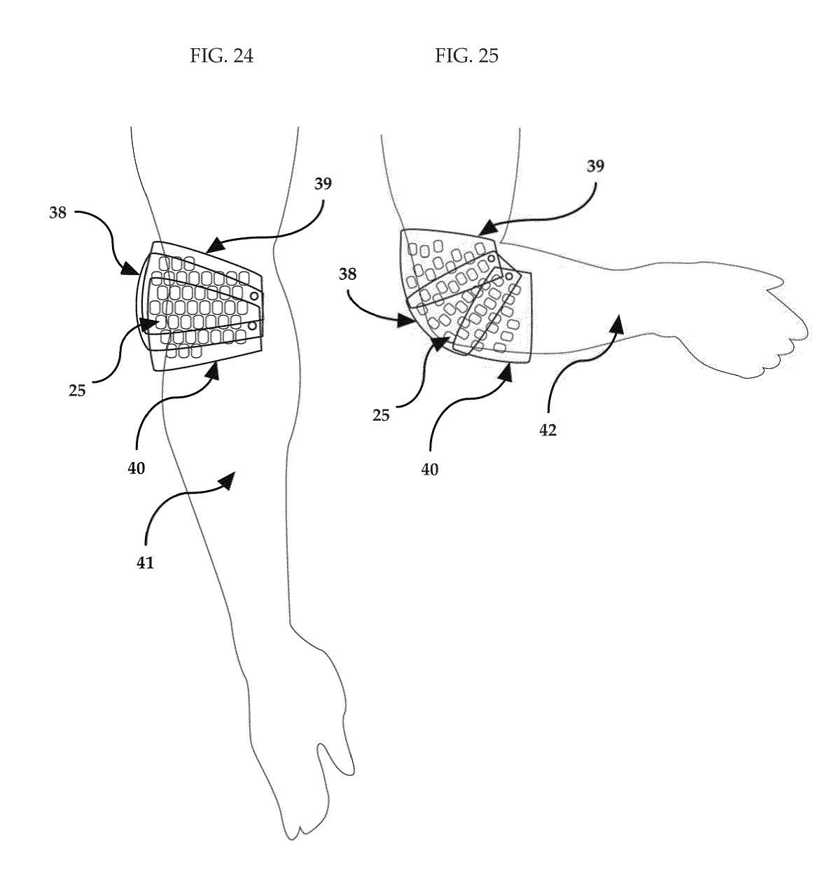

FIGS. 24 and 25 show the protective plate assembly depicted in FIGS. 21-23, positioned on a person's arm 41 and used like a protective elbow guard or elbow pad. As depicted in FIG. 25, in one example of it use, as the wearer flexes or bends his or her arm, plate elements 38 and 40 pivot or “slide out” from under plate element 38, to cover and protect the elbow area.

FIGS. 26-30 depict an alternative embodiment of the protective plate assembly and the plate elements, in which the plate elements 43-45 are relatively flat and not concave and are joined together by pivots 46-47. If the plates are folded for example, the plate element 45 may be positioned underneath plate element 44, and plate element 44 may be positioned underneath plate element 43. Plate elements 44 and 45 may be joined by pivot 46. Plate elements 43 and 44 may be joined by pivot 47.

The protective plate assembly may be preferably attached to a flexible substrate 20 (not depicted in FIGS. 26 and 30) by pivot points 46 and 47.

FIG. 27 depicts the relative positions of plate elements 43-45, by showing in dotted lines 48 the perimeter of plate element 44 located behind, or underneath, plate element 43.

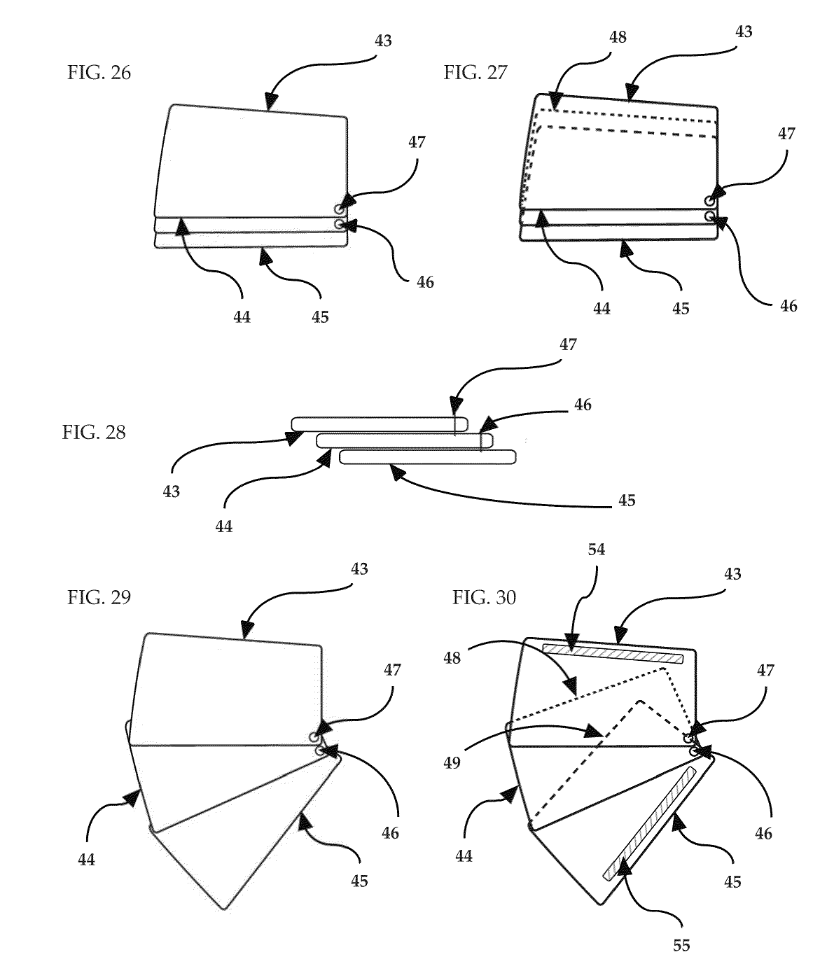

FIG. 28 depicts a side-view of the protective plate assembly, including the relative positions of plate elements 43-45.

As depicted in FIG. 29, pivot 46 permits plate element 45 to rotate and “pivot out” or “slide out” from beneath plate element 44. Likewise, pivot 47 permits plate element 44 to rotate and “pivot out” or “slide out” from beneath plate element 43.

FIG. 30 depicts the relative positions of plate elements 43-45, by showing in dotted lines 48 and 49 the perimeters of plate elements 44 and 45, respectively, located behind, or beneath, plate element 43.

Optionally, protective padding material may be placed underneath the protective plate assembly incorporating plate elements 43-45, in order to provide cushioning and additional protection against shock and impact. Again, the protective padding material may be of the type depicted in FIGS. 1-14. Alternatively, the protective padding material may include the padding assembly shown in FIG. 31. In this embodiment, the protective plate assembly and the padding material are optionally bonded or affixed to a flexible or stretchable substrate, such as flexible substrate 20 (not depicted in FIGS. 26-30).

Optionally, protective padding material placed underneath the protective plate assembly incorporating plate elements 43-45 may be bonded to plate element 43 along points on the edge 54, and to plate element 45 along points on the edge 55, so that the protective padding material flexes and stretches as plate element 45 rotates and “pivots out” or “slides out” from beneath plate element 44, and plate element 44 rotates and “pivots out” or “slides out” from beneath plate element 43, as depicted in FIG. 29.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. The following examples are offered by way of illustration of the present invention, and not by way of limitation.

What is claimed is:

1. A padding composite comprising at least one substrate connected to cushioning element having a middle and distal part, slidably affixed to the substrate.

2. The padding composite of claim 1, wherein the substrate is made of flexible material.

3. The padding composite of claim 2, wherein at least one part of the cushioning element is affixed to the substrate.

4. The padding composite of claim 3, wherein the part of the cushioning element affixed to the substrate is the distal part.

5. The padding composite of claim 1, wherein the cushioning element is made of foam, or soft plastic.

6. The padding composite of claim 1, wherein the substrate is made of flexible, stretchable, or elastic material, such as fabric, mesh, rubber, silicone, soft plastic, synthetic fabric such as spandex or LYCRA®, or composite material that is suitably elastic.

7. The padding composite of claim 1, wherein the cushioning element is mounted, glued, sewn, or fused to the substrate.

8. The padding composite of claim 1, wherein a plurality of cushioning elements are positioned adjacent to each other and contact each other when the padding composite is not stretched.

9. The padding composite of claim 1, wherein the cushioning element has trapezoid cross-section.

10. The padding composite of claim 8, wherein the cushioning elements interlock with each other when the padding composite is not stretched.

11. The padding composite of claim 1, wherein the cushioning element is connected to two substrates, at least one on each side of the cushioning element.

12. The padding composite of claim 1, wherein the cushioning element is made of at least two different types of materials.

13. The padding composite of claim 1, wherein the cushioning element has attached to it another cushioning element of a different material.

14. A folding protective plate comprising at least one substrate connected to plate element having a middle and distal part, slidably affixed to the substrate.

15. The folding protective plate of claim 14, wherein the substrate is made of flexible material.

16. The folding protective plate of claim 15, wherein at least one part of the plate element is affixed to the substrate.

17. The folding protective plate of claim 16, wherein the part of the plate element affixed to the substrate is the distal part, which is adhesion edge.

18. The folding protective plate of claim 14, wherein the plate element is made of hard or resilient materials resistant to impact, puncture, or abrasion, such as plastic, ceramic, metal, hard leather, or resilient rubber.

19. The folding protective plate of claim 14, wherein the substrate is made of flexible, stretchable, or elastic material, such as fabric, mesh, rubber, silicone, soft plastic, synthetic fabric such as spandex or LYCRA®, or composite material that is suitably elastic.

20. The folding protective plate of claim 14, wherein the plate element is mounted, glued, sewn, or fused to the substrate.

21. The folding protective plate of claim 20, wherein a plurality of plate elements are positioned adjacent to each other and contact each other when the substrate is not stretched.

22. The folding protective plate of claim 14, wherein the plate element is placed over padding material.

23. The folding protective plate of claim 22, wherein the padding material is a padding composite comprising at least one substrate connected to cushioning element having a middle and distal part, slidably affixed to the substrate.

24. The folding protective plate of claim 22, wherein the padding material is comprised of foam element.

25. The folding protective plate of claim 17, wherein the adhesion edge comprises one, two, three, four, five, six, seven, or eight sides of a the plate element along its perimeter.

26. The folding protective plate of claim 17, wherein the plate element is concave shaped.

27. The folding protective plate of claim 14, wherein a plurality of plate elements are joined at a pivot.
